(19) United States
(12) Patent Application Publication
(10) Pub. No.: US 2013/0242592 A1
(43) Pub. Date: Sep. 19, 2013

(54) HEAT CONDUCTING LAMP BASE AND LED LAMP INCLUDING THE SAME

(71) Applicant: Onn-Fah Foo, Kowloon (HK)

(72) Inventor: Onn-Fah Foo, Kowloon (HK)

(73) Assignee: MASS TECHNOLOGY (H.K.) LIMITED, Kowloon (HK)

(21) Appl. No.: 13/988,502

(22) PCT Filed: Nov. 23, 2010
(86) PCT No.: PCT/CN2010/079001

§ 371 Date: May 20, 2013

(51) Int. Cl. F21V 29/00; F21V 29/02

(52) U.S. Cl. CPC F21V 29/22; F21V 29/02; F21V 29/30; F21S 48/323
USPC 362/547; 362/382; 362/373

(57) ABSTRACT

A heat conducting lamp base (100) includes a heat conducting portion (120) and a power socket (110) electrically connected to a LED light source (130). The heat conducting portion (120) is made of a thermally conductive material and has at least one heat conducting surface (126). The heat conducting surface (126) is contacted with a heat conducting member (140) of the LED light source (130) so as to facilitate the heat conduction. The heat conducting portion (120) is coupled to at least one part of the power socket (110) and to a heat sink (300) to allow dissipation of heat generated by the LED light source (130). A LED lamp comprising the heat conducting lamp base is provided. The heat conducting lamp base solves the heat dissipation problem of high power LEDs and permits the lamps of small size.

### TECHNICAL FIELD

The present invention relates to the field of illuminating lamps. More specifically, the present invention relates to a lamp base capable of heat conduction and a light-emitting diode (LED) illuminating lamp comprising the heat conducting lamp base.

### BACKGROUND OF THE INVENTION

As a solid state light source with huge development potentials, LEDs (light-emitting diodes) emerged in the sixties of the 20^{th} century and have attracted increasing attention for their advantages such as long life span, safety, environmental friendliness, small size, light weight and low power consumption such that they are becoming to take the place of traditional high pressure halogen lamps in a wide range of lighting applications. The emergence of high-power LEDs (HPLEDs) accelerates the replacement of traditional illuminative light sources by the LEDs and makes it possible to apply LED lamps in scenarios where high-power illumination is required.

HPLEDs, such as illuminating lamps with powers in the range of dozens of Watts to thousands of Watts, are a development trend. However, LEDs would produce a large amount of heat in operation. If this heat is not promptly dissipated, the performance of the LEDs will be affected, resulting in high light fades and shortened life span. HPLEDs have higher requirements for heat dissipation as more heat needs to be dissipated. Because the problem of the heat dissipation remains with the HPLEDs, replaceable LED light sources with high power have not yet been developed, while one piece (irreplaceable) LED lamps presently have a power up to around 100 Watts. Only when the heat dissipation problem of the HPLEDs is solved and the light fades of the LEDs is minimized can the application of HPLED illuminating lamps become widely popularized.

Nowadays, various attempts have been made to solve the heat dissipation problem of LED illuminating lamps. For example, Chinese invention patent application 200910002486.1 in the name of the Applicant discloses an LED reflector lamp, comprising an LED chip light source panel in tight contact with a heat conducting plate integrated with a heat sink, creating a path for good heat conducting and dissipation. The heat generated by the LED light source is dissipated through the path of the light source panel—the heat conducting plate—the heat sink, which reduces the temperature of the LED light source. In addition, the LED reflector lamp may have no lampshade at the opening of the reflector cup, allowing the LED light source to communicate directly with air so as to facilitate the heat dissipation, which further reduces the heat energy when the LED is luminous. Therefore, the problem of heat generation of the HPLED reflector lamps is solved.

Another Chinese invention patent application no. 200810218685.1 titled “LED lamp” discloses an LED lamp comprising an LED heat dissipating substrate on which at least one LED chip is fixed, a metal heat dissipation member connected to the LED heat dissipating substrate for thermal conduction, and a case. The LED lamp further comprises a heat dissipating fan, wherein the metal heat dissipation member is located between the heat dissipating fan and the LED heat dissipating substrate. In that invention, the heat is dissipated by the heat dissipating fan arranged in the vicinity of the heat dissipating substrate.

A further Chinese invention patent application no. 201010177036.9 discloses a heat dissipating device and an LED lamp utilizing said heat dissipating device. Said heat dissipating device comprises a heat dissipating body consisting of a cylindrical heat dissipating base and heat dissipating fins surrounding the heat dissipating base, and an air passage with a central through-hole. The air passage is fixed to one of the end surfaces of the heat dissipating body with the through-hole vertical to the end surface. The light source part and the power source part are respectively mounted on the end surfaces of the heat dissipating device to make use of the air passage structure for improved heat dissipating efficiency of the heat dissipating body.

The various heat dissipating devices or structures available in the prior art for LED lamps are all provided in the body of the lamps, so the lamps are generally of large size. It is undesirable that such an arrangement cannot effectively solve the heat dissipation problem of the HPLED lamps, because it is impossible for the heat dissipating devices or structures to indefinitely increase their heat dissipating area to cater for the heat generation of HPLEDs, if they are provided in the body of the lamps. Notably, the prior art heat dissipating devices lack the ability to adapt for the LEDs with a power of hundreds of Watts and even thousands of Watts.

Therefore, the present invention proposes a novel technical solution in which the heat generated by the LED is transferred to a lamp base which is connected to a heat dissipating device, thus solving the heat dissipation problem of LED lamps and the problem of replacement of traditional lamps with LEDs. One of the notable advantages of the invention is that the efficiency of heat dissipation of HPLEDs can be significantly improved. A lamp base that is capable of heat conduction and acts as a part of the heat dissipating path has never been found in the art until now.

### SUMMARY OF THE INVENTION

The purpose of the present invention is to overcome the disadvantages of the prior art by providing a heat conducting lamp base, through which the heat generated during the luminescence of the LED light source can be effectively dissipated out by various means. As no heat dissipating device or structure needs to be arranged in the main part of the lamp, the size of the lamp can be reduced and the structure of the lamp can be simplified, while effective heat dissipation can be obtained.

The aim of the present invention is realized by the following technical solution, wherein a heat conducting lamp base is provided, comprising a power socket electrically connected to a LED lamp, and further comprising a heat conducting portion, which has at least one surface in thermally conductive contact with a heat conducting member fixed to the LED light source. The heat conducting portion is made of a thermally conductive material and is coupled to at least one part of the power socket and to a heat sink to allow dissipation of heat generated by the LED light source.

In a preferred embodiment of the present invention, the heat conducting portion comprises a cooling medium piping connected between a cooling medium inlet and a cooling medium outlet and in thermally conductive contact with the heat conducting portion. Advantageously, the cooling medium piping extends through the heat conducting member fixed to the LED light source, and the cooling medium piping and the heat sink form a closed loop.

An adaptor can be provided at each of the cooling medium inlet and the cooling medium outlet for convenient connection to an external cooling medium piping.

In an embodiment of the present invention, the cooling medium is air and the heat sink is an external blower. In another embodiment of the present invention, the cooling medium is water or alcohol and the heat sink is an external cooler.

Alternatively, the heat conducting portion can be thermally coupled to the casing of the LED lamp to allow dissipation of heat generated by the LED light source through the casing. The heat conducting lamp base can be mounted inside the casing and in thermally conductive contact with the bottom of the casing through the bottom surface of the heat conducting portion.

In order to enhance the heat transfer between the LED light source and the heat conducting portion of the lamp base, a heat conducting adjuvant selected from graphite flake or radiating oil can be provided between the surface of the heat conducting portion and the heat conducting member fixed to the LED light source.

Generally, the heat conducting portion is made of a thermally conductive material selected from graphite flake, aluminum, aluminum alloy, copper, rose copper, ceramics or thermally conductive plastics.

Another aspect of the present invention provides a LED lamp, comprising:

a control circuit,

at least one LED light source which is controlled by the control circuit,

a heat conducting member to which the at least one LED light source is fixed in a thermally conductive manner,

wherein the LED lamp further comprises a heat conducting lamp base as described above, and the heat conducting member is in thermally conductive contact with at least one surface of the heat conducting portion of the lamp base.

The lamp can further comprise a casing thermally coupled to the heat conducting portion of the lamp base, and the control circuit and the heat conducting member fixed to the LED light source are mounted inside the casing. Thus, the heat is transferred to the casing and then dissipated into the air.

The LED lamps of the present invention can be provided as a car headlight. In this case, the car's radiator may be used as the heat sink, and the heat generated by the LED light source can be dissipated by way of heat exchange in a closed loop formed by the car radiator and the cooling medium piping of the heat conducting portion of the lamp base. Alternatively, the heat sink can be an external cooling device, which forms a closed loop with the cooling medium piping of the heat conducting portion of the lamp base to dissipate the heat.

Unlike traditional lamps in which the heat sink is mounted on the body of the lamps, in the present invention, it is the lamp base that is provided with the ability of heat conduction, so that the heat generated by the LED light source can be conveniently transferred through the heat conducting lamp base to an additional heat sink, especially an external heat sink. Thus, the mode and area of heat dissipation are no longer limited to the lamp itself. As long as the external heat sink has the sufficient heat dissipation capability, all the heat in the lamp can be transferred out, thereby ensuring that the LED would not be overheated and the life span of the LED lamp can be extended. Therefore, the problem of heat dissipation of the HPLEDs is solved. According to the invention, the lamp base itself does not serve as a main heat dissipating medium, but rather cooperates with the external heat sink for heat dissipation as a whole. This design allows for a wide range of application of LED lamps, particularly in the application of heat dissipation of the HPLED lamps, especially those with a power of dozens of Watts or even thousands of Watts, such as car headlights, traffic lights, stadium or gymnasium lighting, and illuminating lamps for stages.

As the heat sink is no longer provided in the body of the lamp, the size of the lamp can be reduced. Besides, the heat conducting lamp base of the present invention is formed by coupling a known power socket in the prior art and a heat conducting portion, making it extremely convenient to manufacture and maintain the lamp base.

The following description of the conception, the detailed structure and the technical effects of the present invention is given with reference to the accompanying drawings, in order to make it easier to fully understand the purpose, the characteristics and the effects of the present invention.

### BRIEF DESCRIPTION OF DRAWINGS

FIG. 1 is a perspective view of a heat conducting lamp base according to a first embodiment of the present invention, showing the heat conducting lamp base is connected with a heat conducting member of the LED light source.

FIG. 2 is a perspective exploded bottom view of the heat conducting lamp base and the heat conducting member of the LED light source of FIG. 1.

FIG. 3 is a perspective exploded top view of the heat conducting lamp base and the heat conducting member of the LED light source of FIG. 1.

FIG. 4 is a front view of the heat conducting lamp base and the heat conducting member of the LED light source of FIG. 1.

FIG. 5 is a sectional view taken along line A-A of FIG. 4.

FIG. 6 is a perspective sectional view taken along line A-A of FIG. 4.

FIG. 7 is a front view of a heat conducting lamp base and a heat conducting member of an LED light source according to a second embodiment of the present invention.

FIG. 8 is a top view of the heat conducting lamp base and the heat conducting member of the LED light source of FIG. 7.

FIG. 9 is a sectional view of the heat conducting lamp base and the heat conducting member of the LED light source of FIG. 7.

FIG. 10 is a perspective exploded view of a heat conducting lamp base and a heat conducting member of an LED light source according to a third embodiment of the present invention.

FIG. 11 is a sectional view of the heat conducting lamp base and the heat conducting member of the LED light source of FIG. 10.

FIG. 12 is a perspective view of a car headlight comprising a heat conducting lamp base according to the present invention, wherein the car's radiator is used as an external heat sink for the headlight.

FIG. 13 is a perspective view of a car headlight comprising a heat conducting lamp base according to the present invention, wherein an external cooler is used as an external heat sink for the headlight.

### DETAILED DESCRIPTION OF EMBODIMENTS

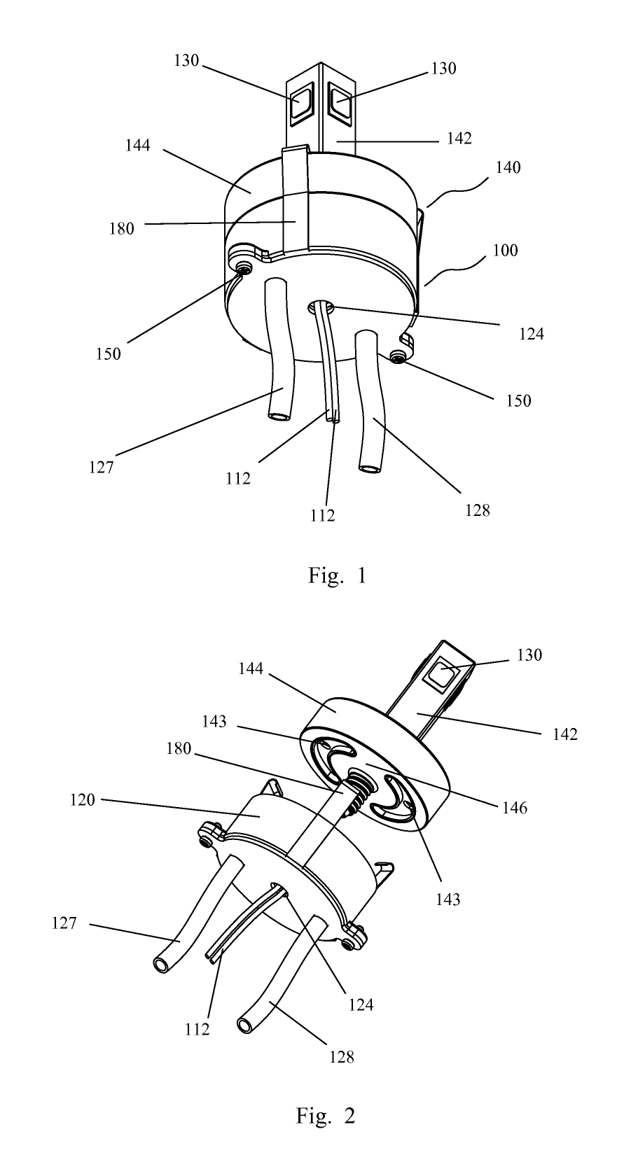

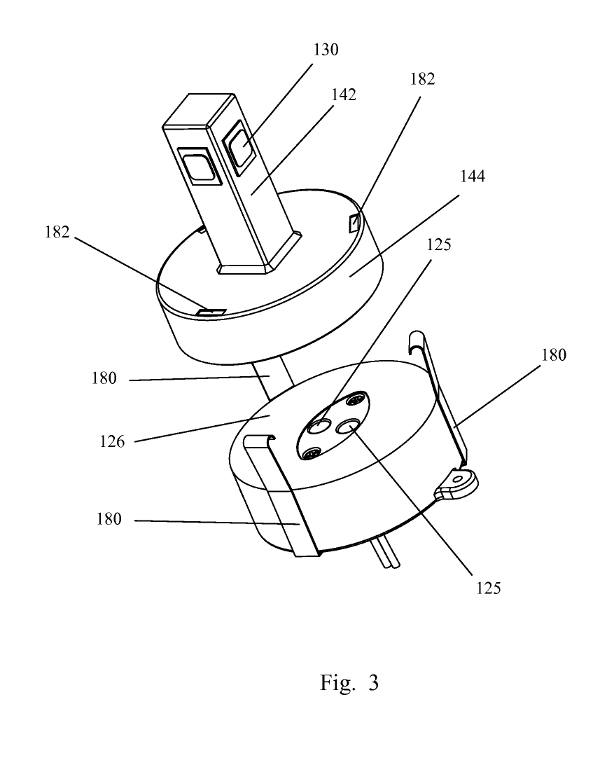

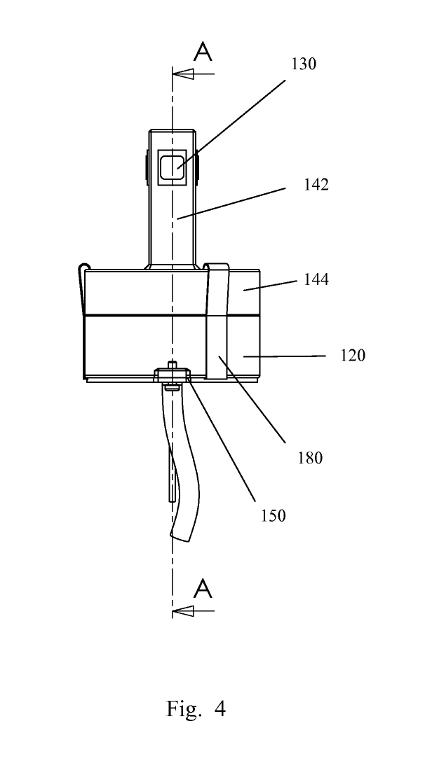

Referring to FIGS. 1-6, a heat conducting lamp base 100 according to a first preferred embodiment of the present invention is illustrated. The heat conducting lamp base 100 comprises a power socket 110 and a heat conducting portion 120. The power socket 110 comprises a socket body provided with an accommodating chamber 114 and two power supply terminals connected to a power supply, the two power supply terminals being connected respectively to power lines 112. The power socket 110 further comprises an electric connection terminal, which is electrically connected to an LED light source 130 for powering the LED light source 130. The power socket 110 can be any power socket known in the art, which will not be described in detail herein as it is not the essence of the present invention.

In the embodiment as illustrated in FIGS. 1-3, there are 4 LED light sources 130. A heat conducting member 140 consists of a cuboidal upper part 142 and a cylindrical lower part 144 extending downwards from the bottom surface of the upper part 142. The bottom surface 146 of the lower part 144 corresponds in size and shape with and comes into thermally conductive contact with a surface of the heat conducting portion of the lamp base. The four LED light sources are fixed, in a heat conductive way, on the four respective side surfaces of the upper part 142 of the heat conducting member 140 to create a heat conduction path of LED light sources—heat conducting member—heat conducting portion of the lamp base. The path allows the heat generated by the LED light sources to be conducted to the heat conducting portion of the lamp base and then to the heat sink for heat dissipation, which will be described in detail herein below.

The heat conducting portion 120 is made of a thermally conductive material, including but not limited to graphite, aluminum, aluminum alloy, copper, rose copper, ceramics or heat conducting plastics. In this embodiment, the heat conducting portion 120 is cylindrical and has a recess 122 formed in its center portion for accommodating the power socket 110, and a through-hole 124 in communication with the recess 122 formed on its bottom for power lines 112 to pass therethrough. The power socket 110 can be fixed on the recess 122 in any manner known in the prior art, such as threaded connection or clamping.

The heat conducting portion 120 is provided with a heat conducting surface 126 in thermally conductive contact with the bottom surface 146 of the lower part 144 of the heat conducting member 140. The contact between these two surfaces can be either plane surface contact or curved surface contact, depending on the practical applications and needs. In order to maintain a good thermally conductive contact between the surface 126 of the heat conducting portion and the heat conducting member 140 of the LED light source, clamping means may be used to clamp them together. In this embodiment, the clamping means comprises three clamps 180 placed in even angular intervals along the circumference of the heat conducting portion 120 to cooperate with three notches 182 provided on the lower part 144 of the heat conducting member 140, as shown in FIG. 3. The heat conducting portion 120 and the heat conducting member 140 can be clamped tightly together by snap-fitting the clamps 180 into the notches 182. Of course, other fastening means such as screws are possible for maintaining a good thermally conductive contact between the surfaces 126 and 146 in order to obtain good heat conduction. In addition, a heat conducting adjuvant such as graphite flakes or radiating oil may be provided between the surface 126 of the heat conducting portion and the bottom surface 146 of the lower part 144 of the heat conducting member 140, so as to enhance the heat transfer and the heat conduction between the LED light source and the heat conducting portion of the lamp base.

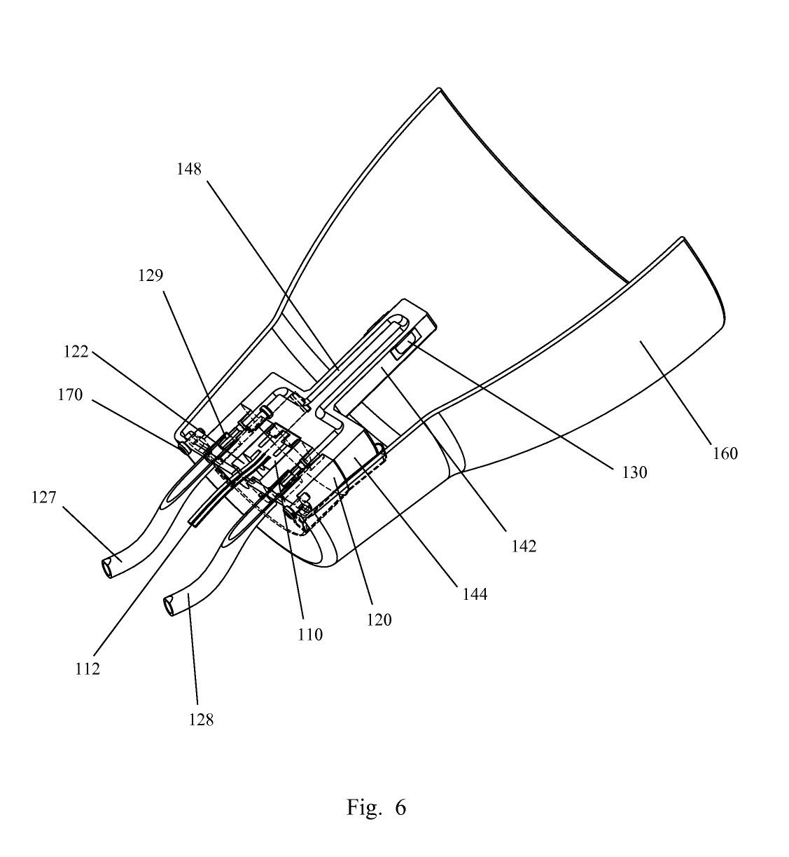

Inside the heat conducting portion 120 is provided a first passage 125, which extends from the bottom to the top on the left side and then from the top to the bottom on the right side. A cooling medium inlet piping 127 and a cooling medium outlet piping 128 are both placed in the passage 125. In this embodiment, the cooling medium pipings 127 and 128 extend beyond the top of the heat conducting portion 120 and communicate with the piping 148 provided within the heat conducting member of the LED light source, as shown in FIG. 6, which will be elaborated herein below. Both the cooling medium inlet piping 127 and the cooling medium outlet piping 128 are configured to be in thermally conductive contact with the heat conducting portion 120 to permit heat exchange between the cooling medium and the LED light source for heat transfer by the cooling medium. The cooling medium can be a gas such as air, a liquid such as water, or a phase-change liquid such as alcohol. An adaptor 129 can be provided respectively at the inlet and the outlet of the cooling medium in order to connect to external pipings.

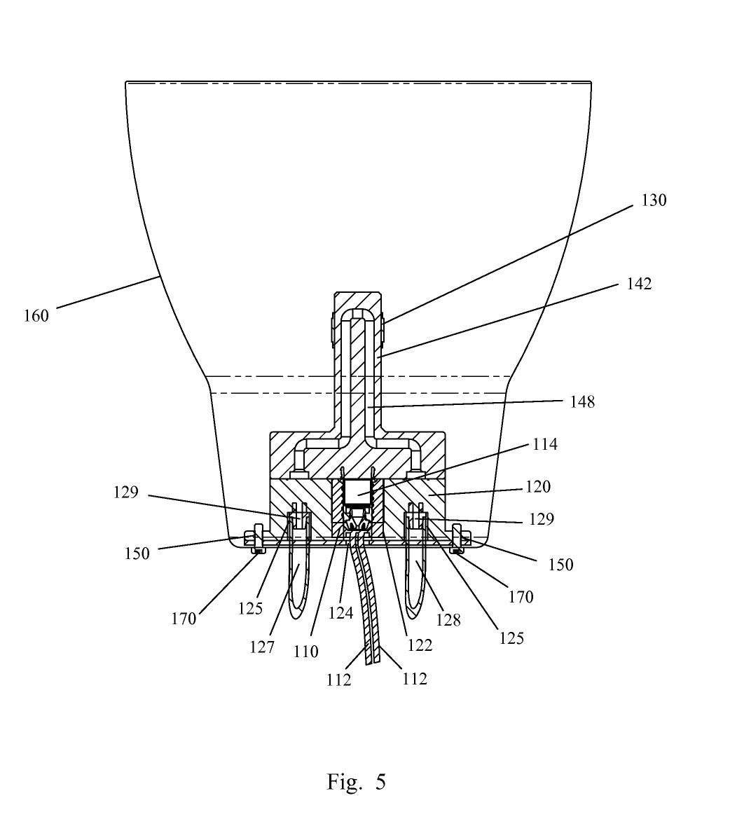

Advantageously, the cooling medium extends through the upper part 142 and the lower part 144 of the heat conducting member. For this purpose, a second passage 143 running through the upper part 142 and the lower part 144 is provided inside the heat conducting member. The cooling medium inlet piping 127 and the cooling medium outlet piping 128 are in communication with the piping 148 provided within the second passage 143, as shown in FIGS. 5 and 6. The purpose of such a design is to obtain better heat dissipation.

The cooling medium inlet piping 127 and the cooling medium outlet piping 128 form a closed loop with an external heat sink through the external cooling medium piping. Of course, an open loop is possible. The external heat sink can be selected from a heat exchange, a cooling tower, or a heat dissipater, or any cooling device known in the prior art.

A screw hole 150 is provided on each of two sides of the bottom of the heat conducting lamp base 100. The two screw holes are aligned with the through-holes on the bottom of a casing 160 of the lamp, and the heat conducting lamp base 100 can be fixed onto the casing by screws 170, as shown in FIGS. 5 and 6. In this case, the bottom surface of the heat conducting portion comes into thermally conductive contact with the bottom of the casing for further heat dissipation through the casing, in order to enhance the effect of heat dissipation. Of course, due to the presence of the external heat sink in this embodiment, it is not necessary for the casing 160 to be in the thermally conductive contact with the heat conducting portion 120, in which case the casing 160 is not restricted to a heat dissipation material.

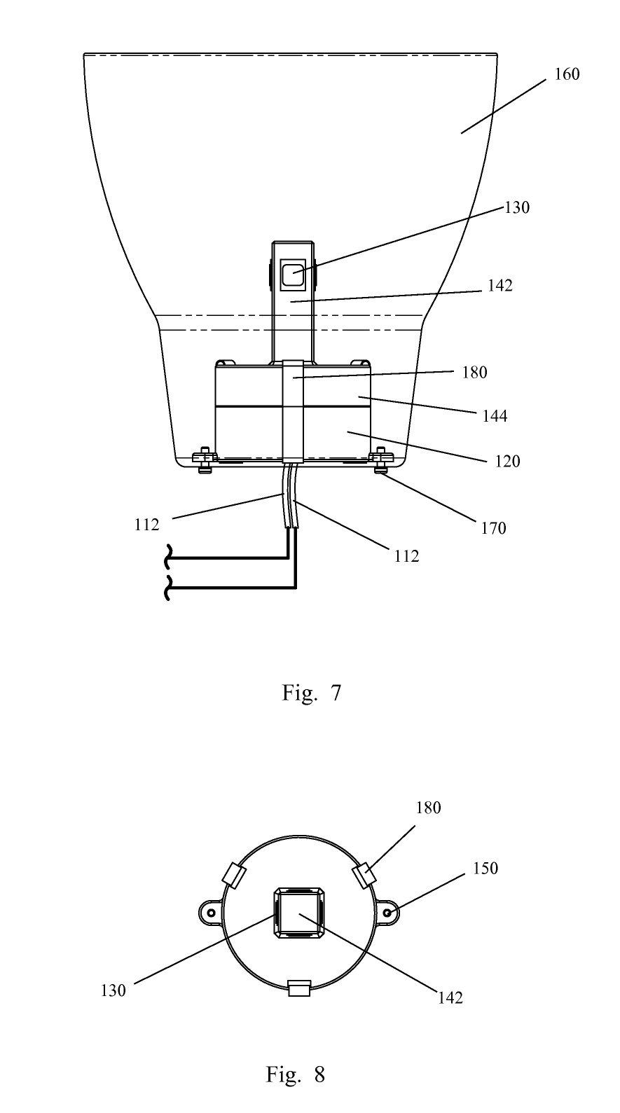

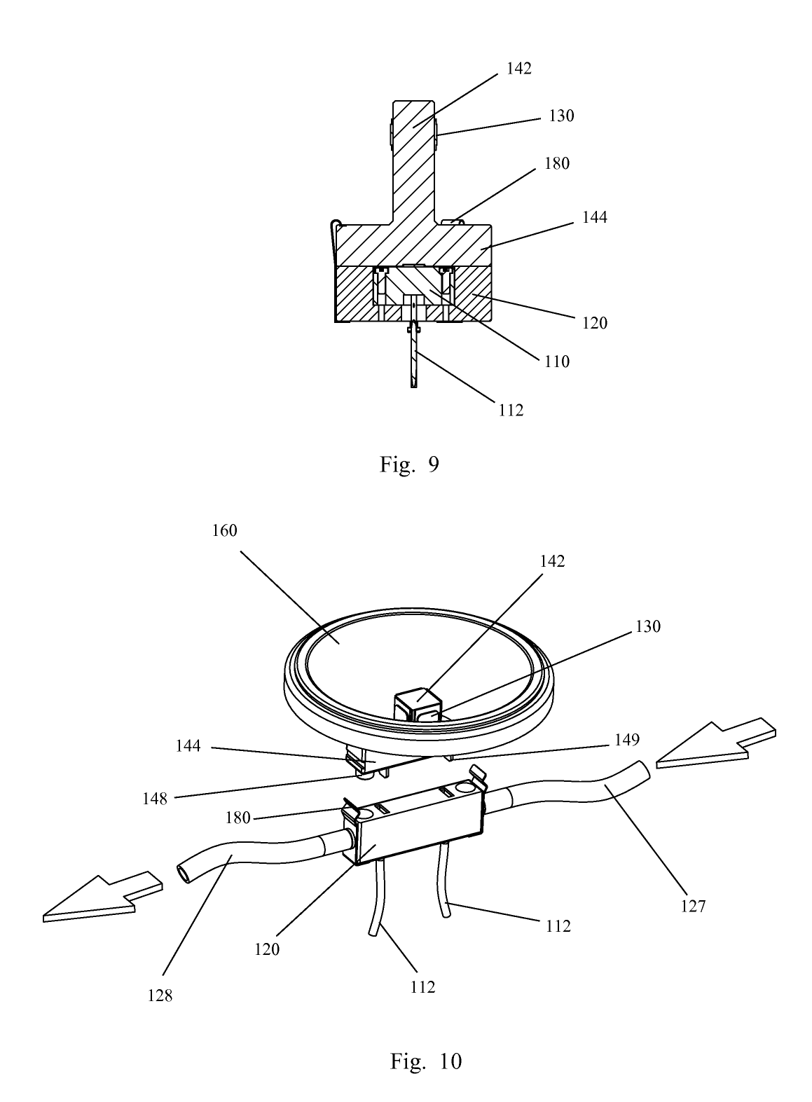

FIGS. 7-9 illustrate a heat conducting lamp base according to a second embodiment of the present invention. The lamp base of this embodiment is substantially identical in structure to the one discussed in the first embodiment, but differs in the absence of a cooling medium piping inside the heat conducting portion 120. Therefore, the casing 160 of the lamp has to be made of a material with good heat conducting properties, such as aluminum or aluminum alloy. Besides, the heat conducting portion 120 must contact with the casing 160 in a thermally conductive way in order to dissipate the heat transferred to the heat conducting portion of the lamp base along the heat conduction path of LED light source—heat conducting member—heat conducting portion through the casing 160 of the lamp. As shown in FIGS. 7 and 9, the bottom surface of the heat conducting portion 120 is in plane surface contact in the thermally conductive way with the inner surface of the bottom of the casing 160. This embodiment is particularly suitable for scenarios that do not require a high level of heat dissipation.

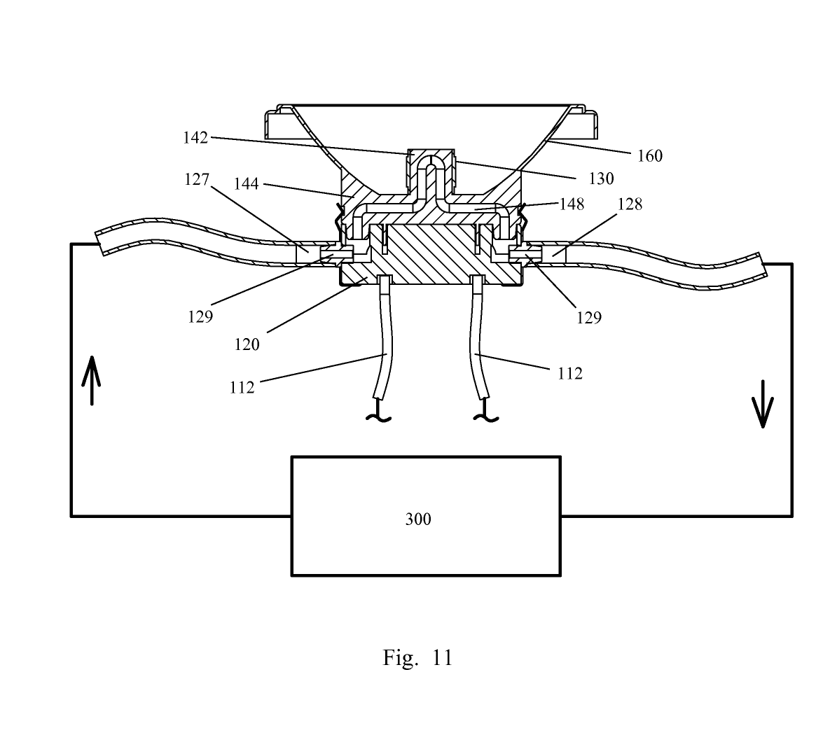

FIGS. 10 and 11 illustrate a heat conducting lamp base according to a third embodiment of the present invention. In this embodiment, the heat conducting portion 120 is in the shape of cuboid, and the lower part 144 of the heat conducting member 140 of the LED light source is correspondingly cuboidal. The heat conducting portion 120 and the lower part 144 are clamped tightly together by snap-fitting the clamps 180 provided on the two ends of the heat conducting lamp base 100 into bulges formed on the two ends of the lower part 144, in order to maintain a good heat conduction. Two electric pins 149 of the LED light source extend from the bottom surface of the lower part 144 of the heat conducting member 140, forming electrical connection with the power socket 110 on the lamp base and creating a closed loop with the power lines 112. As can be seen in FIG. 10, the cooling medium inlet and the cooling medium outlet are respectively provided on the two end surfaces of the cubodial heat conducting portion 120. The cooling medium supplied by an external heat sink 300 is introduced through the cooling medium inlet piping 127, flows through the piping 148 inside the heat conducting member 140, and then comes out of the cooling medium outlet piping 128 to leave the heat conducting lamp base and returns to the external heat sink 300, thereby dissipating the heat within the LED lamp.

The casing 160 of the lamp in this embodiment is not coupled to the heat conducting lamp base 100. Specifically, an opening is formed on the bottom of the casing 160 of the present invention, and the opening is shaped and sized to match with the upper part 142 of the heat conducting member 140, allowing the upper part 142 of the heat conducting member 140 to be inserted into the interior of the casing 160 through the opening. In this case, the casing itself can serve as a component assisting heat dissipation, or may not have the ability to dissipate heat.

The other structures and functions of this embodiment are basically identical to those of the first embodiment described above.

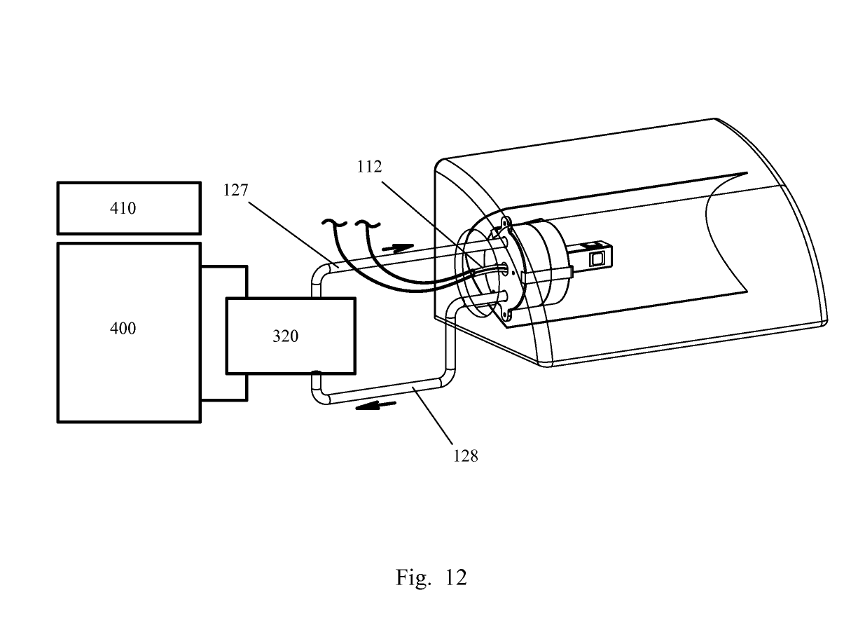

FIG. 12 illustrates a specific LED lamp comprising the heat conducting lamp base according to the present invention, wherein the LED lamp is a car headlight. As illustrated in the figure, the heat generated when the car headlight is turned on is transferred to the heat conducting portion of the heat conducting lamp base, and then transferred to the cooling medium inside the cooling medium piping through heat conduction. Subsequently, the cooling medium returns to an external heat exchanger 320. As known to a person skilled in the art, the car has its own radiator 400 comprising a cooling water tank, the water in which is further cooled down by a fan 410. The cold source of the heat exchanger 320 of the car headlight is provided by the cooling water used in the radiator 400 of the car.

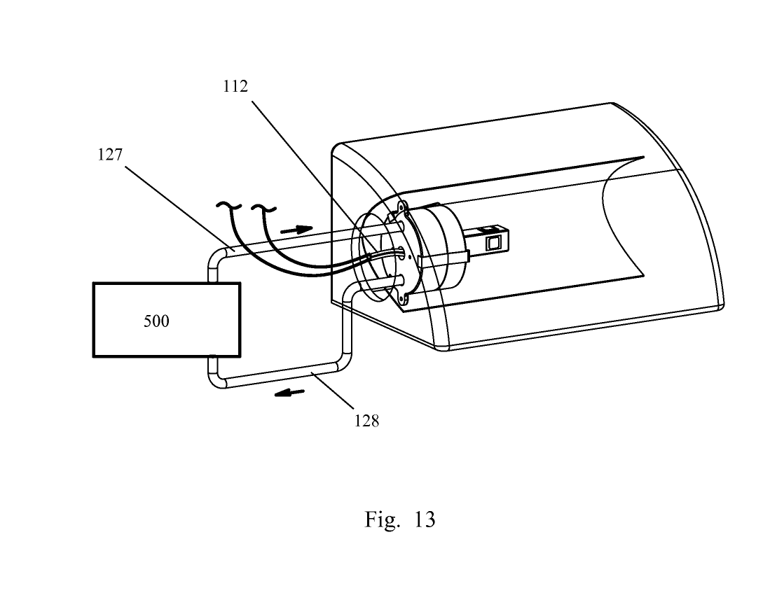

FIG. 13 illustrates another specific LED lamp comprising the heat conducting lamp base according to the present invention, wherein the LED lamp is also a car headlight. Unlike the car headlight shown in FIG. 12, the external heat sink is an additional cooling device instead of the car's radiator. The cooling device can be any cooling device known in the art, such as a cooler.

Therefore, the present invention provides a heat conducting lamp base, which does not serve as a heat dissipating medium, but rather as a heat conducting means to transfer the heat generated by the LED lamp to the heat sink for heat dissipation. As a result, the present invention provides a new technical solution to the heat dissipation problem of LED lamps, and in particular effectively solves the heat dissipation problem of the HPLEDs.

Furthermore, the heat conducting lamp base according to the present invention is developed through modification of existing lamp bases, and does not require significant restructuring of the existing lamp bases, so as to provide the ease and convenience of application of the present invention.

Although several preferred embodiments of the present invention have been described with reference to the accompanying drawings, the present invention should not be limited to structures and operations exactly identical to the above description and accompanying drawings. Through logic analysis, inference or limited experiments, those skilled in the art can make numerous improvements and modifications to the above embodiments, which, however, are all within the protection scope of the present invention.

What is claimed is:

1. A heat conducting lamp base comprising a power socket electrically connected to a LED lamp, characterized in that the heat conducting lamp base further comprises a heat conducting portion which has at least one surface in thermally conductive contact with a heat conducting member fixed to a LED light source and which is made of a thermally conductive material, and the heat conducting portion is coupled to at least one part of the power socket and to a heat sink to allow dissipation of heat generated by the LED light source.

2. The heat conducting lamp base according to claim 1, characterized in that the heat conducting portion comprises a cooling medium piping connected between a cooling medium inlet and a cooling medium outlet and in thermally conductive contact with the heat conducting portion.

3. The heat conducting lamp base according to claim 2, characterized in that the cooling medium piping extends through the heat conducting member fixed to the LED light source.

4. The heat conducting lamp base according to claim 2, characterized in that an adaptor is provided at each of the cooling medium inlet and the cooling medium outlet for connection to an external cooling medium piping.

5. The heat conducting lamp base according to claim 4, characterized in that the cooling medium piping of the heat conducting portion, the external cooling medium piping and the heat sink form a closed loop.

6. The heat conducting lamp base according to any one of claims 2, characterized in that the cooling medium is air and the heat sink is an external blower.

7. The heat conducting lamp base according to any one of claims 2, characterized in that the cooling medium is water or alcohol, and the heat sink is an external cooler.

8. The heat conducting lamp base according to claim 1, characterized in that the heat conducting portion is thermally coupled to a casing of the LED lamp to allow dissipation of heat generated by the LED light source through the casing.

9. The heat conducting lamp base according to claim 8, characterized in that the heat conducting lamp base is mounted inside the casing, and a bottom surface of the heat conducting lamp portion is in thermally conductive contact with a bottom of the casing.

10. The heat conducting lamp base according to claim 1, characterized in that a heat conductive adjuvant selected from graphite flake or radiating oil is provided between the surface of the heat conducting portion and the heat conducting member fixed to the LED light source.

11. The heat conducting lamp base according to claim 1, characterized in that the thermally conductive material is selected from graphite, aluminum, aluminum alloy, copper, rose copper, ceramics or heat conductive plastics.

12. The heat conducting lamp base according to claim 1, characterized in that the heat conducting portion and the heat conducting member are secured together by fastening means.

13. The heat conducting lamp base according to claim 1, characterized in that the heat conducting portion is in the shape of a cylinder and at least one part of the heat conducting member is cylindrical, so that they are in the thermally conductive contact through a cylindrical surface.

14. The heat conducting lamp base according to claim 1, characterized in that the heat conducting portion is in the shape of a cuboid and at least one part of the heat conducting member is cuboidal so that they are in the thermally conductive contact through a rectangular surface.

15. A LED lamp, comprising:
a control circuit,
at least one LED light source which is controlled by the control circuit,
a heat conducting member to which the at least one LED light source is fixed in a thermally conductive manner,
characterized in that the LED lamp further comprises a heat conducting lamp base according to any one of claims 1, wherein the heat conducting member is in thermally conductive contact with at least one surface of the heat conducting portion of the lamp base.

16. The lamp according to claim 15, characterized in that the lamp further comprises a casing thermally coupled to the heat conducting portion of the lamp base, and the control circuit and the heat conducting member fixed to the LED light source are mounted inside the casing.

17. The lamp according to claim 15, characterized in that the lamp is a car headlight, and the heat sink is a car radiator which forms a closed loop with the cooling medium piping of the heat conducting portion of the lamp base.

18. The lamp according to claim 15, characterized in that the lamp is a car headlight, and the heat sink is an external cooling device which forms a closed loop with the cooling medium piping of the heat conducting portion of the lamp base.

19. The heat conducting lamp base according to claim 3, characterized in that the cooling medium is air and the heat sink is an external blower.

20. The heat conducting lamp base according to claim 3, characterized in that the cooling medium is water or alcohol, and the heat sink is an external cooler.
